(19) United States
(12) Patent Application Publication
(10) Pub. No.: US 2005/0270619 A1
(43) Pub. Date: Dec. 8, 2005

(54) Electrochromic color display having different electrochromic materials

(75) Inventors: Mark Thomas Johnson, Eindhoven (NL); Lucas Josef Maria Schlangen, Eindhoven (NL); Hendrik Johannes Boudewijn Jagt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/521,859

(22) PCT Filed: Jun. 26, 2003
(86) PCT No.: PCT/IB03/02906

§ 371 Date: Jan. 21, 2005

(30) Foreign Application Priority Data
Jul. 26, 2002 (EP) 02078078.9

(51) Int. Cl. G02F 1/15

(52) U.S. Cl. 359/265

(57) ABSTRACT

An electrochromic display comprises electrochrome pixels (10) which comprise at least a first electrochrome material (EL1) and a second electrochrome material (EL2) between two electrodes (E1, E2). Each of the electrochrome materials (EL1, EL2) has two stable states, in one state at a first voltage across the electrochrome pixel (10) the material is transparent, in the other state at a second voltage across the electrochrome pixel (10) the material absorbs a color and thus is colored. The material changes from the one state to the other state by applying the appropriate one of the first or the second voltage. The amount of change of the absorption of the color depends on the time the appropriate voltage is applied. The first electrochrome material (EL1) changes from a transparent state to a color absorbing state for at least partly absorbing a first color when a pixel voltage (VP) across the electrochrome pixel has the first value (V1). The first electrochrome material (EL1) changes from the color absorbing state to the transparent state when the pixel voltage (VP) has a second value (V2) which has a polarity opposite to the first value (V1). The second electrochrome material (EL2) changes from a transparent state to a color absorbing state for at least partly absorbing a second color different than the first color when the pixel voltage (VP) has a third value (V3) which has an absolute value smaller than an absolute value of the first value (V1). The second electro-chrome material (EL2) changes from the color absorbing state to the transparent state when the pixel voltage (VP) has a fourth value (V4) which has a polarity opposite to the third value (V3). An absolute value of the fourth value (V4) is smaller than an absolute value of the second value (V2).

The invention relates to an electrochromic display, a driver circuit for driving an electrochrome pixel of the electrochromic display, a display apparatus comprising the electrochromic display and the driver circuit, and a method of driving an electrochrome pixel of the electrochromic display.

U.S. Pat. No. 4,304,465 discloses an electrochromic display device which has a polymer film on the display electrode. In the writing step, the polymer film on the display electrode is oxidized to a colored, non-transparent form. In the erasing step, the polymer film is reduced to the neutral transparent form. The known electrochromic display device is not able to show a multicolor picture.

It is an object of the invention to provide an electrochromic display device which is able to generate a multicolor picture.

A first aspect of the invention provides an electrochromic display as claimed in claim 1. A second aspect of the invention provides a driver circuit for driving an electrochrome pixel of the electrochromic display as claimed in claims 8 to 10. A third aspect of the invention provides a display apparatus comprising the electrochromic display and the driver circuit, as claimed in claim 11. A fourth aspect of the invention provides a method of driving an electrochrome pixel of the electrochromic display as claimed in claims 12 to 14. Advantageous embodiments are defined in the dependent claims.

The electrochromic display comprises electrochrome pixels which comprise at least a first electrochrome material and a second electrochrome material between two electrodes. The optical state of the electrochrome material depends on the voltage applied across the pixel. At a first voltage across the electrochrome pixel the material is transparent, at a second voltage across the electrochrome pixel the material absorbs a color and thus appears colored. The material changes from the one state to the other state by applying the appropriate one of the first or the second voltage. The amount of change of the absorption of the color depends on the time the appropriate voltage is applied.

The first electrochrome material changes from a transparent state to a color absorbing state to at least partly absorb a first color if a pixel voltage across the electrochrome pixel has the first value. The first electrochrome material changes from the color absorbing state to the transparent state if the pixel voltage has a second value which has a polarity opposite to the first value.

The second electrochrome material changes from a transparent state to a color absorbing state to at least partly absorb a second color different than the first color if the pixel voltage has a third value which has an absolute value smaller than an absolute value of the first value. The second electro-chrome material changes from the color absorbing state to the transparent state if the pixel voltage has a fourth value which has a polarity opposite to the third value. An absolute value of the fourth value is smaller than an absolute value of the second value.

If such monochromic electrochromes are used, gray scales are created by controlling the degree of coloration by limiting the amount of charge injected in the electrochromic layer. In principle it would be possible to generate a multicolor display by stacking at least two such electrochromic panels with electrochromic layers having different colors. A full color display would be obtained by using three electrochromic panels with different colors (preferably CMY, C=cyano, M=magenta, and Y is yellow). However, this will requires that three panels are stacked on top of each other, causing parallax problems and which drastically increase the price of the display. Each of the panels comprises at least a substrate, a working electrode with electrochromic material, an electrolyte, a counter electrode with counter reaction capability, and a substrate. Thus each panel has its own driving electronics on one of the substrates which drive the pixel electrodes, this adds greatly to the complexity, reduces the brightness of the display, and adds to costs.

In the display in accordance with the invention, the electrochrome materials require different voltage values to change state. This enables to drive the pixels with a single set of electrodes only, while still enabling to control the amount of absorption of the different electrochrome materials separately.

Such a color electrochromic display is easy to manufacture because the layer(s) of electrochromes can be applied easily, for example by using screen-printing, ink-jet printing or coating techniques.

In an embodiment as defined in claim 2, the first electrochrome material and the second electrochrome material are present in two separate layers. The layers are stacked on top of each other between the electrodes.

In an embodiment as defined in claim 3, the first electrochrome material and the second electrochrome material are implemented as a one layer mixture. An advantage of this approach is an improved homogeneity of the response.

In an embodiment as defined in claim 4, the one layer mixture is absorbed on the nano-porous area of one of the electrodes. The electrode consists of a nano-porous conducting material, for example, nano structured titanium di-oxide. The nano-structured layer may cover an ITO or a FTO electrode. This has the advantage that a highly improved diffusion of counter-ions for charge compensation in the electrochromic switching process, and simultaneously an enhanced electron transfer to and from the electrochromes is achieved, resulting in an improvement of the response time of the device. Despite the monolayer coverage of such a nano-porous electrode, a sufficient optical density in the colored states is still ensured due to the very high surface area of the nano-porous electrode.

In an embodiment as defined in claim 5, only two different electrochromic materials corresponding to two different colors are present in the pixel, while a color filter is provided for the third color. This prevents that it is necessary to identify three electrochromic materials with different coloration voltages (voltages required to change the material towards the color absorbing state) and bleaching voltages (voltages required to change the material towards the transparent state) which are also not damaged by (short) exposure to higher voltages.

For example, each of the two different electrochromic materials is provided in a separate layer. In a predetermined pixel, one of the electrochromic materials is able to absorb red (i.e. appears cyan), the other electrochromic material is able to absorb green (i.e. appears magenta), and the color filter absorbs blue (i.e. appears yellow). A full color matrix display is obtained by alternating the color combinations of different pixels. For example, in a pixel adjacent to the predetermined pixel, one of the electrochromic materials is able to absorb red (i.e. appears cyan), the other electrochromic material is able to absorb blue (i.e. appears yellow), and the color filter absorbs green (i.e. appears magenta).

In another aspect of the invention as defined in one of the claims 8 to 10, the driver circuit supplies pixel voltages across the pixel in an order which enables to set the amount of absorption of each one of the two electrochromic materials separately. In the embodiment in accordance with the invention as defined in claim 8, first all electrochromic materials are bleached (put in the transparent state) then a voltage is applied which is able to change the absorption of all the electrochromic materials. This voltage is applied as long as required to obtain the desired amount of coloration of the electrochromic material which requires the highest voltage to change from transparent state to absorbing state. Then a voltage is applied able to bleach the other electrochromic material while the electrochromic material which requires the highest voltage is unaffected. And finally, a voltage is applied able to change the absorption of the other electrochromic material while the electrochromic material which requires the highest voltage is unaffected. This voltage is applied as long as required to obtain the desired amount of coloration of the other electrochromic material.

In the embodiment in accordance with the invention as defined in claim 9, first all electrochromic materials are colored then a voltage is applied which is able to change the absorption of all the electrochromic materials towards the transparent state.

In another aspect of the invention as defined in claim 10, the driver circuit supplies pixel voltages across the pixel in an order which enables to set the amount of absorption of each one of the two electrochromic materials separately. The pixel is driven based on the difference in color of the existing information and the color of successive information to be displayed. First the difference is detected between the present amount of coloration of the first electrochrome material which requires the highest voltage to change state and the required future amount of coloration. The appropriate voltage is applied across the pixel to change the coloration of the first electrochrome material in the correct direction, directly. The coloration of the second electrochrome material will change together with the coloration of the first electrochrome material. The resulting coloration of the second electrochrome material is compared with the required coloration and a voltage is applied across the pixel to change the coloration of the second electrochrome material in the correct direction, directly. This way of driving increases the switching (addressing) speed and reduces the power dissipation and degradation.

The sequential way of driving as claimed in claim 8 has the drawbacks that a lot of steps have to be performed for writing a pixel such that it has the correct total amount of absorption and the correct color is reached. Further, the fact that several materials are successively colored and bleached, before being finally colored (or the other way around: first bleached and then colored as defined in claim 9) causes more charge to be moved than is required in the driving scheme as claimed in claim 10. This increases the power dissipation and reduces the lifetime of the display as degradation will occur faster if more charge is flowing.

These and other aspects of the invention are apparent from and will be elucidated with reference to the embodiments described hereinafter.

In the drawings:

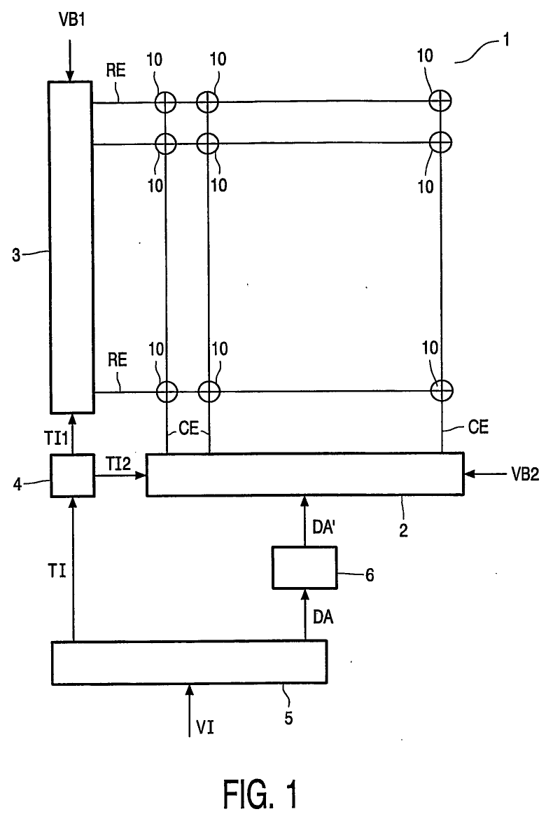

FIG. 1 shows a block diagram of an electrochromic display and its driving circuit,

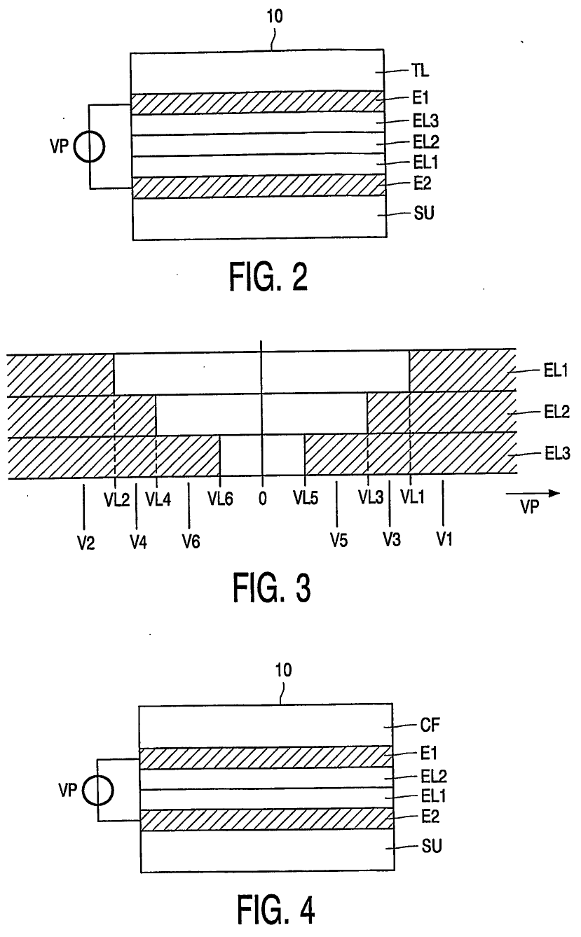

FIG. 2 shows the structure of an electrochrome pixel in accordance with the invention,

FIG. 3 shows the behavior of the three different electrochromic materials for elucidating driving schemes of the electrochromic display,

FIG. 4 shows the structure of an electrochrome pixel in accordance with the invention,

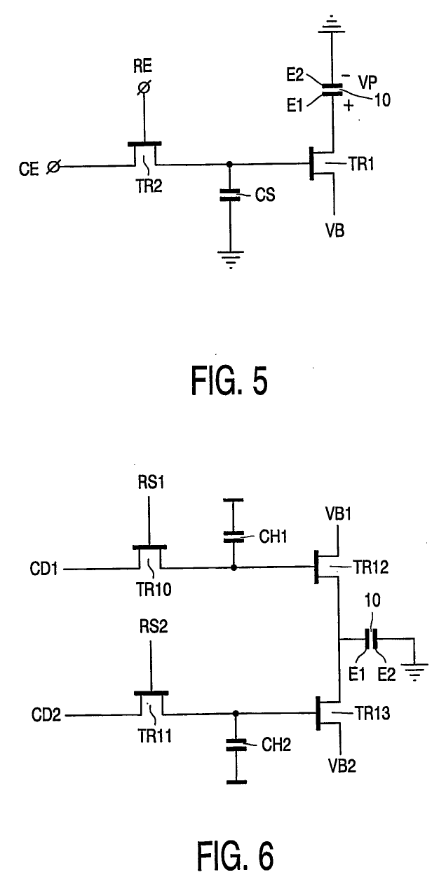

FIG. 5 shows an embodiment for driving an electrochromic pixel in an active matrix display, and

FIG. 6 shows another embodiment for driving an electrochromic pixel in an active matrix display.

FIG. 1 shows a block diagram of an electrochromic display and its driving circuit. The electrochromic display 1 comprises a matrix of electrochrome pixels 10 (further also referred to as pixels) associated with intersections of row (or select) electrodes RE extending in the row direction and column (or data) electrodes CE extending in the column direction. A row driver 3 supplies select voltages to the row electrodes RE, and a column driver 2 supplies data voltages to the column electrodes CE. A data processor 5 receives input video VI and supplies timing information TI to a controller 4, and a data signal DA to a comparator 6. The timing information TI may indicate the fields and lines in the video signal VI. The comparator 6 supplies the data signal DA′ to the column driver 2. The comparator 6 is optional, if the comparator 6 is omitted, the data signals DA′ and DA are equal. The controller 4 supplies a first control signal TI1 to the row driver 3 and a second control signal TI2 to the column driver 2. The timing information TI and the control signals TI1 and TI2 control the proper sequence of voltages supplied to the electrochrome pixels 10, depending on the desired driving scheme.

For a passive matrix display, the function of the row and column electrodes RE, CE and the row and column drivers 3, 2 may be exchanged, such that the row electrodes extend in the column direction.

The row driver 3 receives a power supply voltage VB1, and the column driver 2 receives a power supply voltage VB2.

FIG. 2 shows the structure of an electrochrome pixel 10 in accordance with the invention. The pixel 10 comprises from top to bottom: a transparent layer TL, a first electrode E1 which is part of the row electrode RE, a third electrochromic layer EL3, a second electrochromic layer EL2, a first electrochromic layer EL1, a second electrode E2 which is part of the column electrode CE, and a substrate SU. The pixel voltage VP supplied by the row and column drivers 2, 3 between the first and the second electrodes E1, E2 is shown as a voltage source VP. In addition, the pixel structure may further comprise an electrolyte layer to further assist the coloration process.

In a practical implementation, the pixel 10 comprises an electrolyte. This electrolyte may be present as a separate layer stacked within the cell. The electrolyte is deposited between the stack of electrochromes or mixture of electrochromes and the counter electrode E1. Furthermore, the counter electrode E1 maybe redox-active, or a separate redox-active layer is present between counter electrode E1 and the elektrolyte layer, or a combination of both may be present.

FIG. 3 only shows one pixel element. Next to this pixel element other pixels are present. The substrate will therefore not be limited to only one pixel, however, the color filter and the electrochromic layers should be pixelated and be physically separated from neighboring pixels. The electrolyte however might extend laterally over the entire display. The counter electrode might be one common electrode or also pixelated.

The three electrochrome layers EL1, EL2 and EL3 may correspond in any order with materials showing a yellow, magenta or cyan coloration, respectively. Instead of the three electrochrome layers EL1, EL2 and EL3, it is also possible to mix the materials in a single layer. Thus, because the materials used is the important issue, and not whether these materials are divided over three layers or combined in two or even a single layer is relevant to the invention. Therefore, the indices EL1, EL2 and EL3 are further used to indicate the materials. If the materials are divided in three layers, these indices refer to the layers also. Although the three layers EL1, EL2 and EL3 enable a full color display, two layers suffice to make a display able to produce information with different colors. Again the different materials in the two layers may be mixed in a single layer.

FIG. 3 shows the behavior of the three different electrochromic materials for elucidating driving schemes of the electrochromic display. The horizontal axis indicates the voltage VP across the electrochrome material and the vertical axis indicates the amount of coloration of the electrochrome material.

FIG. 3 concerns a full color electrochrome pixel 10 which comprises three different electrochrome materials EL1, EL2, EL3 in three separate layers placed on a white reflecting substrate SU. Each of the three electrochrome materials EL1, EL2, EL3 switches between a fully transparent state and a state that absorbs either red or green or blue light while being transparent for the other two colors. The potential required for this transition varies per electrochrome material EL1, EL2, EL3.

FIG. 3 shows the pixel voltage VP along the horizontal axis. In the vertical direction, the different electrochrome material EL1, EL2, EL3 are shown. The white areas indicate for each color the area of voltages wherein the absorption state of the color does not (or only very slowly) change, the dashed areas indicate the voltages which cause the absorption state to change. In this example, the material increases absorption when a voltage is applied within the right hand dashed part of the bars, and decreases absorption when a voltage is applied within the left hand dashed part of the bars. Dependent on the material used, this may be the other way around.

The first material EL1 does not change state (or changes state only very slowly) if the pixel voltage VP supplied between the electrodes E1 and E2 is in the range from VL2 (which is a negative voltage) to VL1 as indicated by the non-dashed part of the bar indicated by EL1. The dashed part of the bar EL1 for voltages lower than VL2 indicates that the coloration of the layer EL1 decreases if a voltage V2 lower than VL2 is applied. The amount of decrease depends on the time during which the voltage V2 is supplied. The dashed part of the bar for voltages higher than VL1 indicates that the coloration increases if a voltage V1 higher than VL1 is applied. The amount of increase depends on the time during which the voltage V1 is applied.

The second material EL2 does not change state (or changes state only very slowly) if the pixel voltage VP supplied between the electrodes E1 and E2 is in the range from VL4 to VL3 as indicated by the non-dashed part of the bar indicated by EL2. The dashed part of the bar EL2 for voltages lower than VL4 indicates that the coloration of the layer EL2 decreases for voltages lower than VL4. The amount of decrease depending on the time during which the voltage lower than VL4 is supplied. The dashed part of the bar for voltages higher than VL3 indicates that the coloration increases if a voltage is applied higher than VL3. The amount of increase depends on the time during which the voltage higher than VL3 is supplied. Consequently, when the voltage V4 is applied to the cell 10, the material EL2 will start bleaching while the state of the material EL1 will be substantially unaffected. In the same way, when the voltage V3 is applied to the cell 10, the material EL2 will start to increase the coloration while the state of the material EL1 is substantially unaffected.

The third material EL3 does not change state (or changes state only very slowly) if the pixel voltage VP supplied between the electrodes E1 and E2 is in the range from VL6 to VL5 as indicated by the non-dashed part of the bar indicated by EL3. The dashed part of the bar indicated by EL3 for voltages lower than VL6 indicates that the coloration of the layer EL3 decreases if a voltage lower than VL6 is applied. The amount of decrease depending on the time during which the voltage lower than VL6 is supplied. The dashed part of the bar for voltages higher than VL5 indicates that the coloration increases if a voltage higher than VL5 is applied. The amount of increase depends on the time during which the voltage higher than VL5 is supplied. Consequently, when the voltage V6 is applied to the cell 10, the material EL3 will start bleaching while the state of the other materials EL1 and EL2 will be substantially unaffected. In the same way, when the voltage V5 is applied to the cell 10, the material EL3 will start to increase the coloration while the state of the other materials EL1 and EL2 is substantially unaffected.

In this pixel 10 all the materials (or layers, if three layers are present) EL1, EL2, EL3 can be given any level of coloration by using the following drive scheme.

Firstly, a voltage V2 which is lower than the voltage VL2 is supplied between the electrodes E1 and E2 of the pixel 10 during a period of time long enough to make all the layers EL1, EL2, EL3 transparent (the layers are bleached).

Secondly, the voltage V1 which is higher than the voltage VL1 is supplied between the electrodes E1 and E2. All the layers EL1, EL2, EL3 start to color. The voltage V1 is removed at the instant the first layer EL1 has reached the desired absorption value.

Thirdly, the voltage V4 is applied in the range between VL2 and VL4 causing the second and third layers EL2 and EL3 to bleach while the first layer EL1 is unaffected.

Fourthly, the voltage V3 in the range from VL3 to VL1 is applied, the first layer EL1 remains unaffected, while the second and the third layers EL2 and EL3 start to color. The voltage V3 is removed at the instant the second layer EL2 has reached the desired absorption value.

In a fifth step, the voltage V6 is applied in the range between VL4 and VL6, the third layer EL3 is bleached while the first and the second layers EL1 and EL2 are unaffected. In a sixth step, a voltage V5 in the range from VL5 to VL3 is applied, the first and second layers EL1 and EL 2 remain unaffected, while the third layer EL3 starts to color. The voltage V5 is removed at the instant the third layer EL3 has reached the desired absorption value.

At this point, all the layers EL1, EL2 and EL3 have reached their desired amount of coloration.

It is possible to change the order of the bleaching and colorizing steps.

Although this drive scheme is able to drive the electrochromic display 1 with the specially selected electrochromic materials EL1, EL2 and EL3 to display full color images, this sequential addressing approach due to the many steps which have to be performed is relatively slow in writing an image. In addition, several materials EL1, EL2 and EL3 are successively bleached and colored several times before the final coloration is reached. Consequently, a lot of charge is moved in addressing a pixel 10 causing an increased power dissipation, and a faster degradation of the material EL1, EL2 and EL3.

A method of addressing in which the addressing speed is increased and the power dissipation and degradation is reduced, drives the pixels 10 such that the materials EL1, EL2 and EL3, in a first step, starting from the existing amount of coloration, are either bleached or colored as much as required to cause the desired new coloration of the pixel 10.

This drive scheme when applied to the construction of the pixel 10 as shown in FIG. 2 successively performs next steps:

In a first step, the current coloration of the first layer EL1 is compared by the comparator 6 with the required coloration in the successive new image. If the new coloration is more than the current coloration, the voltage V1 is supplied to the pixel 10. If the new coloration is less than the current coloration, the voltage V2 is supplied to the pixel 10. Additional electrical circuitry in the pixel of an active matrix display (such as additional TFTs) may be required to carry out the simultaneous application of one or the other voltage to the pixel. All layers EL1, EL2 and EL3 start to change color. The voltage V1 or V2 is removed at the instant the first layer EL1 has reached its desired new absorption value.

In a second step, the current coloration of the second layer EL2 is compared by the comparator 6 with the required coloration in the successive new image. If the new coloration is more than the current coloration (including the action of V1 or V2), the voltage V3 is supplied to the pixel 10. If the new coloration is less than the current coloration, the voltage V4 is supplied to the pixel 10. The layers EL2 and EL3 start to change color, the first layer EL1 is unaffected. The voltage V3 or V4 is removed at the instant the second layer EL2 has reached its desired new absorption value.

In a third and last step, the current coloration of the third layer EL3 is compared by the comparator 6 with the required coloration in the successive new image. If the new coloration is more than the current coloration (including the action of V1, V2, V3 or V4), the voltage V5 is supplied to the pixel 10. If the new coloration is less than the current coloration, the voltage V6 is supplied to the pixel 10. The third layer EL3 starts to change color, the first and second layers EL1 and EL2 are unaffected. The voltage V5 or V6 is removed at the instant the third layer EL3 has reached its desired new absorption value.

In this way, only three voltage cycles have to be applied, reducing the addressing time and the power dissipation. In general, the above driving scheme applies to any cell 10 which contains three electrochromic materials EL1, EL2, EL3, it is not relevant that these materials are present in three layers as is shown in FIG. 2. Thus, in general, the term layer(s) may be replaced by material(s).

By way of example, a material which has the behavior shown in FIG. 3 is described now. In a test pixel (electrochromic cell) 10, a layer of 300 nanometer thick PEDOT is spin-coated onto an ITO/glass substrate which is used as a working electrode E2. A pixel 10 is constructed by gluing this substrate to a further ITO/glass substrate which is used as the counter electrode E1. A cell 10 gap between these two electrode layers E1 and E2 is filled with an electrolyte solution containing 0.2 M LiClO₄ (lithium perchlorate) in K-butyrolactone. The cell 10 is colored by applying a voltage of 3 volts across it, which causes a rapid blue coloration of the PEDOT layer by a reduction reaction of the PEDOT. The cell 10 starts to bleach slowly at a voltage of −1 volts across it. For voltages between −0.5 and 2.5 volts the color of the cell changes hardly in time. At −1.5 volts a fast bleaching occurs, and after some time the PEDOT is oxidized to its conducting and almost transparent state.

The above drive schemes are related to a full color display with three different electrochromic materials. These drive schemes, in a simplified version, by leaving out one cycle, can also be used to drive a color display with two different electrochromic materials. Such a display can only display colors caused by mixing the two colors corresponding to the two materials.

FIG. 4 shows the structure of an electrochrome pixel in accordance with the invention. This pixel 10 comprises from top to bottom: a color filter CF, a first electrode E1 (the reference electrode), a first electrochromic layer EL1, a second electrochromic layer EL2, a first electrochromic layer EL1, a second electrode E2 (the pixel electrode), and a substrate SU. The substrate may also comprise TFTs and other electronic components (not illustrated). The pixel voltage VP supplied by the row and column drivers 2, 3 between the first and the second electrodes E1, E2 is shown as a voltage source VP. In addition, the pixel structure may further comprise an electrolyte layer to further assist the coloration process.

The two electrochrome layers EL1 and EL2 may correspond in any order with materials showing a yellow, magenta or cyan coloration, respectively. Instead of the two electrochrome layers EL1 and EL2, it is also possible to mix the materials in a single layer. The color of the color filter CF has to be selected as the complementary color of the colors of the two electrochrome layers EL1 and EL2. If, for example, the color of the electrochrome layers EL1 and EL2 is cyan and magenta, the color filter CF should be yellow. By alternating the color combinations of the layers EL1 and EL2 and the color filter CF for adjacent pixels 10, it is possible to provide a color display. Because only two instead of three different electrochrome materials EL1 and EL2 have to be addressed, more materials can be selected which have the different voltage levels for bleaching and coloration.

In the same manner as elucidated with respect to FIG. 2, only one cell is shown, and the electrolyte is not shown.

The color filter CF is preferably located as close as possible to the electrochrome materials EL1 and EL2.

FIG. 5 shows an embodiment for driving an electrochromic pixel in an active matrix display.

The electrochromic display 1 has an active matrix structure, wherein each pixel 10 comprises thin film transistors (further referred to as TFT) TR1 and TR2 in order to drive the pixel 10. The main current path of the drive TFT TR1 is arranged between the pixel electrode E1 of the pixel 10 and a power line voltage VB. The common electrode E2 of the pixel 10 is connected to ground. The main current path of the addressing TFT TR2 is connected between a column electrode CE and the control electrode of the drive TFT TR1. The control electrode of the addressing TFT TR2 is connected to a select electrode RE.

The select voltages on the rows RE are used to address a row RE of pixels 10 by activating the addressing TFT TR2 to conduct. The data voltage from the column CE is then passed to the control electrode of the drive TFT TR1 and determines whether this TFT is conducting, or non-conducting. The drive TFT TR1 connects the pixel electrode E1 to a power supply line on which the power supply voltage VB is present. The data voltage therefore determines whether the pixel 10 is attached (pixel is driven) or not attached (pixel is not driven) to the power supply voltage VB. A memory element in the pixel circuit (for example a storage capacitor CS) ensures that the pixel 10 remains driven until the next addressing period, one frame time later. At this point, the power supply voltage VB can be changed to supply a different one of the voltages V1 to V6 to the pixel 10.

An electrochrome layer EL1, EL2, EL3 can be colored and bleached in the following steps:
(i) The power supply voltage VB is switched to the bleaching voltage, and all pixels 10 are addressed with a high voltage, whereby all pixels 10 are bleached (pixels which are already bleached will do nothing at this stage). The storage capacitor CS ensures that the drive TFT TR1 remains conducting during the hold period.
(ii) All pixels 10 are addressed with a low voltage. This turns the drive TFTs TR1 off. The power supply voltage VB is switched to the coloring voltage.
(iii) Those pixels 10 in the row selected by the row select voltage on the row RE which require coloring are addressed to a high voltage by a high data voltage on the data electrode CE. The drive TFT TR1 becomes conductive and coloration begins. The storage capacitor CS ensures that the drive TFT TR1 remains conducting during the hold period. When the pixel 10 is sufficiently colored, the pixel 10 is disconnected from the power line by addressing the pixel 10 with a low voltage. When the new image is written, the power supply voltage VB can be powered down.

In this embodiment, the grey level (“intensity”) of the color will be defined by the integral amount of charge passing into the electrochrome layer EL1, EL2, EL3 and hence by the time in which the pixel electrode E1 is connected to the power line.

FIG. 6 shows another embodiment for driving an electrochromic pixel in an active matrix display. In FIG. 6, a more complex pixel circuit is shown whereby an electrochrome layer EL1, EL2, EL3 can be colored and bleached.

A pixel 10 has a pixel electrode E1 and a common electrode E2 connected to ground. A series arrangement of main current paths of two drive TFTs TR12 and TR13 is arranged between a power supply voltage VB1 and a power supply voltage VB2. The junction of the two drive TFTs TR12 and TR13 is connected to the pixel electrode E1.

A main current path of an address TFT TR10 is arranged between a column electrode CE to receive the column data CD1 and the control electrode of the drive TFT TR12. The control electrode of the address TFT TR10 is connected to a select electrode RE to receive a row select signal RS1. A storage capacitor CH1 is connected to the control electrode of the drive FET TR12.

A main current path of an address TFT TR11 is arranged between a column electrode CE to receive the column data CD2 and the control electrode of the drive TFT TR13. The control electrode of the address TFT TR11 is connected to a select electrode RE to receive a row select signal RS2. A storage capacitor CH2 is connected to the control electrode of the drive FET TR12.

The operation of the pixel circuit is elucidated in the now following. The power supply voltages VB1 and VB2 are set to a bleaching voltage and coloration voltage, respectively. The display is addressed with two voltages: a high voltage causes the drive TFT TR12, TR13 to become conductive, a low voltage stops the conducting state of the drive TFT TR12, TR13. The column data CD1 is used to select pixels 10 which require coloring, and the column data CD2 is used to select pixels 10 which require bleaching. Those pixels 10 which require coloring or bleaching are addressed to a high voltage. The drive TFTs TR12, TR13 become conducting and bleaching or coloration starts. The storage capacitors CH1, CH2 ensure that the drive TFTs TR12, TR13 remain conducting during the hold period. When the pixel 10 is sufficiently colored or bleached, the pixel 10 is disconnected from the power supply voltage VB1, VB2 by addressing the pixel 10 with a low voltage. When the new image is written, the power supply voltages VB1 and VB2 can be powered down.

The addressing of the a pixel 10 is performed by the row select signals RS1 and RS2 and the column data CD1 and CD2.

Again, in this embodiment, the grey level (“intensity”) of the color will be defined by the integral amount of charge passing into the electrochrome layer EL1, EL2, EL3 and hence by the time in which the pixel electrode E1 is connected to the power supply voltages VB1, VB2. As in general no “reset” will be used, it is necessary to know the previous state of the pixel 10 before supplying the correct amount of charge (or discharge) to reach the new grey level. This will require a signal processing approach, wherein the previous grey level is stored in a frame memory, the new grey level is compared with the previous grey level, the required charge determined (via a look-up-table or analytical function), and the desired pixel data is supplied to the pixel 10.

It should be noted that the above-mentioned embodiments illustrate rather than limit the invention, and that those skilled in the art will be able to design many alternative embodiments without departing from the scope of the appended claims.

For example, it would also be possible to use electrodes which generate in-plane fields in combination with the driving approach in accordance with embodiments of the invention. In this way area defined gray scales could be generated for different colors, which could also be used in combination with red, green, or blue electrochromic layers.

The display can be operated either in a transmissive setup, e.g. by lighting the device with a backlight system, but is more likely to be used in reflective setup, e.g. by using a reflector (preferably diffuse) behind the display.

In the claims, any reference signs placed between parentheses shall not be construed as limiting the claim. The word “comprising” does not exclude the presence of elements or steps other than those listed in a claim. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. An electrochromic display comprising
electrochrome pixels comprising at least a first electrochrome material and a second electrochrome material between two electrodes,
the first electrochrome material changing from a transparent state to a color absorbing state for at least partly absorbing a first color when a pixel voltage across the electrochrome pixel has a first value, the first electrochrome material changing from the color absorbing state to the transparent state when the pixel voltage has a second value having a polarity opposite to the first value, and
the second electrochrome material changing from a transparent state to a color absorbing state for at least partly absorbing a second color different than the first color when the pixel voltage has a third value having an absolute value being smaller than an absolute value of the first value, the second electro-chrome material changing from the color absorbing state to the transparent state when the pixel voltage has a fourth value having a polarity opposite to the third value, an absolute value of the fourth value being smaller than an absolute value of the second value.

2. An electrochromic display as claimed in claim 1, wherein the first electro-chrome material and the second electrochrome material are two separate layers.

3. An electrochromic display as claimed in claim 1, wherein the first electro-chrome material and the second electrochrome material are mixed in a one layer mixture.

4. An electrochromic display as claimed in claims 2 or 3, wherein one of the electrodes has a nano-porous surface being covered by the one layer mixture.

5. An electrochromic display as claimed in claim 1, wherein the electrochrome pixels comprise a color filter for filtering a third color being different than the first color and the second color.

6. An electrochromic display as claimed in claim 1, wherein the electrochrome pixels further comprise a third electrochrome material changing from a transparent state to a color absorbing state for at least partly absorbing a third color different than the first and the second color when the pixel voltage has a fifth value having an absolute value being smaller than an absolute value of the third value, the third electro-chrome material changing from the color absorbing state to the transparent state when the pixel voltage has a sixth value having a polarity opposite to the third value, an absolute value of the sixth value being smaller than an absolute value of the fourth value.

7. An electrochromic display as claimed in claim 6, wherein the first, second a third electrochrome material in their color absorbing state appear cyano, magenta, and yellow, respectively.

8. A driver circuit for driving an electrochrome pixel of the electrochromic display as claimed in claim 1, the driver circuit comprising means for applying the pixel voltage across the electrochrome pixel successively as follows:
(i) the pixel voltage has an absolute value and a polarity for changing towards the transparent state of both the first electrochrome material and the second electrochrome material,
(ii) the pixel voltage has an absolute value and a polarity for changing the transparent state into the color absorbing state of both the first electrochrome material and the second electrochrome material, and is applied as long as required to obtain a desired amount of absorption of the first electrochrome material,
(iii) the pixel voltage has an absolute value and a polarity for changing towards the transparent state of the second electrochrome material, while the first electrochrome material is unaffected, and
(iv) the pixel voltage has an absolute value and a polarity for changing the transparent state of the second electrochrome material into the color absorbing state, while the first electrochrome material is unaffected, and is applied as long as required to obtain a desired amount of absorption of the second electrochrome material.

9. A driver circuit for driving an electrochrome pixel of the electrochromic display as claimed in claim 1, the driver circuit comprising means for applying the pixel voltage across the electrochrome pixel successively as follows:
(i) the pixel voltage has an absolute value and a polarity for changing towards the color absorbing state of both the first electrochrome material and the second electrochrome material,
(ii) the pixel voltage has an absolute value and a polarity for changing the color absorbing state into the transparent state of both the first electrochrome material and the second electrochrome material, and is applied as long as required to obtain a desired amount of absorption of the first electrochrome material,
(iii) the pixel voltage has an absolute value and a polarity for changing towards the color absorbing state of the second electrochrome material, while the first electrochrome material is unaffected, and
(iv) the pixel voltage has an absolute value and a polarity for changing the color absorbing state of the second electrochrome material into the transparent state, while the first electrochrome material is unaffected, and is applied as long as required to obtain a desired amount of absorption of the second electrochrome material.

10. A driver circuit for driving an electrochrome pixel of the electrochromic display as claimed in claim 1, the driver circuit comprising
a comparator for comparing a current amount of absorption of the first electrochrome material with a required amount of absorption required for successive information to be displayed,
means for applying the pixel voltage across the electrochrome pixel having an absolute value and a polarity for changing towards the transparent state of both the first electrochrome material and the second electrochrome material, when the required amount of absorption is lower than the current amount of absorption, or for applying the pixel voltage across the electrochrome pixel having an absolute value and a polarity for changing towards the color absorbing state of both the first electrochrome material and the second electrochrome material, when the required amount of absorption is higher than the current amount of absorption,
the comparator being adapted for comparing a current amount of absorption of the second electrochrome material with a required amount of absorption required for successive information to be displayed,
the means for applying the pixel voltage being adapted for supplying the pixel voltage across the electrochrome pixel having an absolute value and a polarity for changing towards the transparent state of the second electrochrome material while the first electrochrome material is unaffected, when the required amount of absorption is lower than the current amount of absorption, or for applying the pixel voltage across the electrochrome pixel having an absolute value and a polarity for changing towards the color absorbing state of the second electrochrome material while the first electrochrome material is unaffected, when the required amount of absorption is higher than the current amount of absorption.

11. A display apparatus comprising the color electrochromic display as claimed in claim 1, and the driver circuit as claimed in any of the claim 8 to 10.

12. A method of driving an electrochrome pixel of the electrochromic display as claimed in claim 1, comprising
applying the pixel voltage across the electrochrome pixel successively as follows:
(i) the pixel voltage has an absolute value and a polarity for obtaining the transparent state of both the first electrochrome material and the second electrochrome material,
(ii) the pixel voltage has an absolute value and a polarity for changing the transparent state into the color absorbing state of both the first electrochrome material and the second electrochrome material, and is applied as long as required to obtain a desired amount of absorption of the first electrochrome material,
(iii) the pixel voltage has an absolute value an a polarity for obtaining the transparent state of the second electrochrome material, while the first electrochrome material is unaffected, and
(iv) the pixel voltage has an absolute value and a polarity for changing the transparent state of the second electrochrome material into the color absorbing state, while the first electrochrome material is unaffected, and is applied as long as required to obtain a desired amount of absorption of the second electrochrome material.

13. A method of driving an electrochrome pixel of the electrochromic display as claimed in claim 1, comprising
applying the pixel voltage across the electrochrome pixel successively as follows:
(i) the pixel voltage has an absolute value and a polarity for obtaining the color absorbing state of both the first electrochrome material and the second electrochrome material,
(ii) the pixel voltage has an absolute value and a polarity for changing the color absorbing state into the transparent state of both the first electrochrome material and the second electrochrome material, and is applied as long as required to obtain a desired amount of absorption of the first electrochrome material,
(iii) the pixel voltage has an absolute value an a polarity for obtaining the color absorbing state of the second electrochrome material, while the first electrochrome material is unaffected, and
(iv) the pixel voltage has an absolute value and a polarity for changing the color absorbing state of the second electrochrome material into the transparent state, while the first electrochrome material is unaffected, and is applied as long as required to obtain a desired amount of absorption of the second electrochrome material.

14. A method of driving an electrochrome pixel of the electrochromic display as claimed in claim 1, comprising
comparing a current amount of absorption of the first electrochrome material with a required amount of absorption required in for successive information to be displayed,
applying the pixel voltage across the electrochrome pixel having an absolute value and a polarity for changing towards the transparent state of both the first electrochrome material and the second electrochrome material, when the required amount of absorption is lower than the current amount of absorption, or for applying the pixel voltage across the electrochrome pixel having an absolute value and a polarity for changing towards the color absorbing state of both the first electrochrome material and the second electrochrome material, when the required amount of absorption is higher than the current amount of absorption,
comparing a current amount of absorption of the second electrochrome material with a required amount of absorption required for successive information to be displayed, and
applying the pixel voltage being adapted for supplying the pixel voltage across the electrochrome pixel having an absolute value and a polarity for changing towards the transparent state of the second electrochrome material while the first electrochrome material is unaffected, when the required amount of absorption is lower than the current amount of absorption, or for applying the pixel voltage across the electrochrome pixel having an absolute value and a polarity for changing towards the color absorbing state of the second electrochrome material while the first electrochrome material is unaffected, when the required amount of absorption is higher than the current amount of absorption.
